(19) United States
(12) Patent Application Publication
(10) Pub. No.: US 2018/0366233 A1
(43) Pub. Date: Dec. 20, 2018

(54) MAGNETIC MIRROR DEVICE AND NEUTRAL BEAM INJECTION METHOD

(71) Applicant: HEFEI INSTITUTES OF PHYSICAL SCIENCE, CAS, Hefei (CN)

(72) Inventors: Yican Wu, Hefei (CN); Dehong Chen, Hefei (CN); Qiusun Zeng, Hefei (CN); Minghuang Wang, Hefei (CN); Jieqiong Jiang, Hefei (CN); Zhibin Chen, Hefei (CN); Yunqing Bai, Hefei (CN); Jie Yu, Hefei (CN)

(73) Assignee: HEFEI INSTITUTES OF PHYSICAL SCIENCE, CAS, Hefei (CN)

(21) Appl. No.: 16/008,138

(22) Filed: Jun. 14, 2018

(30) Foreign Application Priority Data
Jun. 14, 2017 (CN) 201710448870.9

(51) Int. Cl. G21B 1/05; G21B 1/15

(52) U.S. Cl. CPC G21B 1/052; G21B 1/15

(57) ABSTRACT

A magnetic mirror device and neutral beam injection method is provided. The neutral beam is obliquely injected at a higher magnetic field position rather than at the midplane of magnetic mirror device. This method is beneficial for confining a higher density of fast ions at the turning point zone with a higher magnetic field, as well as obtaining a higher mirror ratio by reducing magnetic field intensity at middle plane rather than increasing the maximum magnetic field intensity of the magnetic mirror device. It increases a fusion power density of the fast ions reaction and reduces the end loss power plasma, consequently, higher fusion energy gain can be achieved.

This application claims the priority to Chinese Patent Application No. 201710448870.9, titled “MAGNETIC MIRROR DEVICE OF INJECTION NEUTRAL BEAM AT PLASMA STRONG MAGNETIC FIELD POSITION”, filed on Jun. 14, 2017 with the State Intellectual Property Office of People's Republic of China, which is incorporated herein by reference in its entirety.

### FIELD

The present disclosure relates to the technical field of nuclear fusion energy, and in particular to a magnetic mirror device.

### BACKGROUND

A magnetic mirror is a magnetic confinement fusion device that confines plasma by a special magnetic field with low magnetic field intensity at the middle plane and high magnetic field intensity at both ends. The main feature of the magnetic mirror is using a series of magnetic field coils to form a high magnetic barrier in two ends. So that the charged particles can be confined inside the vacuum chamber of magnetic mirror device.

A gas dynamic trap (GDT) is a kind of axisymmetric magnetic mirror device with a very high magnetic mirror ratio (a ratio of a maximum magnetic field intensity to a minimum magnetic field intensity). The length between two magnetic throats, where is the maximum magnetic field intensity, is greater than an effective mean-free path of the warm ions in the target plasma. So that the distribution of warm ions trapped in the GDT device is isotropic and Maxwellian due to frequent collisions, and therefore many micro-instabilities are suppressed. As the transport behavior of target plasma in the GDT device is under gas-dynamics mode, hence this kind of magnetic mirror device is named gas dynamic trap (GDT).

In the GDT device, high energy neutral particles are obliquely injected into the target plasma by a neutral beam injection system to produce fast ions in plasma. Because of the conservation of magnetic moment and very small spread angle of the fast ions beam, the fast ions will move back and forth inside the GDT plasma along the magnetic field and accumulate in the positions of turning points of fast ions, where locate near the two ends of the GDT device. Those fast ions will constantly collide to each other mainly at turning point zones and fusion reaction occurs.

The GDT device has advantages of simple and compact structure, low plasma temperature and low cost, and thus it is considered as a promising fusion neutron source for testing fusion materials and sub-components, or driving a fusion-fission hybrid reactor to transmute nuclear wastes and breed nuclear fuels.

Fusion energy gain is a ratio of a fusion power produced to a heating power consumed in the plasma, which is usually represented as Q, that is, Q=fusion power/heating power. At present, the fusion energy gain of a magnetic mirror device such as the GDT device is low (much lower than 0.1), which results high engineering requirements, such as high neutral beam injection power and magnetic field intensity.

In order to increase the fusion power as well as the fusion energy gain of magnetic mirror devices, especially the GDT, a promising method is to increase the density of fast ions in the turning point zones in that the fusion power P_{fustion} and the density of fast ions n_{fi} has a relationship showed in P_{fustion} ∝n_{fi}². Another promising method improves the mirror ratio R to improve the plasma temperature and confinement of fast ions, due to that the end loss power of plasma is inversely proportional to the mirror ratio R.

The fast ions' density n_{fi} can be increased by increasing the magnetic field intensity of turning point Bₜ due to the relationship showed in

$$β = \frac{p}{{B}_{t}^{2} / 2 {μ}_{0}} \approx 2 {μ}_{0} \frac{{n}_{fi} {E}_{fi}}{{B}_{t}^{2}} .$$

The β is the plasma beta that is a ratio of plasma pressure to the magnetic pressure.

The relationship between a magnetic field intensity of the position of a turning point Bₜ in the GDT device and a magnetic field intensity of the position of neutral beam injection Bᵢₙⱼ is expressed as Bₜ=Bᵢₙⱼ/(sin²θ), where θ is an angle between a direction for injecting a neutral beam and an axis direction of plasma. However, due to coils arrangement, the θ cannot be too small and is usually not less than 20 degrees.

In conventional GDT device, the neutral beam injection is injected in the midplane where the minimum magnetic field intensity of the conventional GDT magnetic mirror device. That is, the neutral beam is injected in the position of a minimum magnetic field intensity (Bᵢₙⱼ=B₀). With this conventional scheme of neutral beam injection, it is difficult to increase the magnetic field intensity largely in the position of the turning point of the fast ions, even by reducing θ. In addition, the magnetic mirror ratio cannot be increased largely by raising the maximum magnetic field (Bₘₐₓ) due to the limitation of magnet technology, or by reducing the minimum magnetic field (B₀) due to the fact that it will also reduce the magnetic field of turning point (Bₜ) in the conventional neutral beam injection method. Therefore, in general, the traditional neutral beam injection method limits the improvement of Q of the GDT device.

### SUMMARY

In order to solve the problem of low fusion energy gain of the magnetic mirror, which has limited the further development of the GDT device, a magnetic mirror device and a neutral beam injection method are provided in the present disclosure.

In the technical solution in the present disclosure, a magnetic mirror device mainly includes a neutral beam injection system, a magnet system, a vacuum chamber, a plasma gun and other auxiliary equipment.

The magnet system is configured to form a magnetic mirror field. The plasma gun is configured to shoot plasma into the vacuum chamber to form initial target plasma. The neutral beam injection system is configured to inject a neutral beam in a position at higher magnetic field intensity rather than the minimum magnetic field in a midplane.

A neutral beam injection method is further provided in the present disclosure, which is applied in a magnetic mirror device includes a neutral beam injection system, a magnet system, a vacuum chamber and a plasma gun. The neutral beam injection method includes forming a magnetic field by the magnet system; shooting, by the plasma gun, plasma into a vacuum chamber to form initial target plasma; and injecting, by the neutral beam injection system, a neutral beam injects in a position at higher magnetic field intensity rather than in the midplane where the minimum magnetic field intensity of the GDT device.

The principle of the present disclosure is that, by injecting a high energy neutral particle beam into the position of a high-intensity magnetic field in a magnetic mirror device, to improve directly the magnetic field intensity of fast ions turning points according to the relationship of Bₜ∝Bᵢₙⱼ. Then the density of fast ions in the turning point will increase under the relationship of n_{fi}×Bₜ². Therefore, the fusion power is increased with the increment of fast ions' density. Due the Bᵢₙⱼ is different from Bᵢⱼ, the mirror ratio is improved to reduce the end loss power of plasma in the present disclosure. Consequently, the fusion energy gain of the magnetic mirror device will increase by using neutral beam injection method described in the present disclosure.

The technical scheme according to the present disclosure has the following advantages compared with the conventional neutral beam injection method.

(1) With the technical solution according to the present disclosure, the magnetic field intensity of the turning points will be improved, and then the density of the confined fast ions can be increased, which increases the power density of the fusion reaction of the fast ions.

(2) With the technical solution according to the present disclosure, the magnetic mirror ratio can be increased by reducing the intensity of the midplane magnetic field rather than increasing the maximum magnetic field intensity, so as to reduce the end loss power of plasma and increase confinement time of the fast ions, without reducing the magnetic field intensity and density of the fast ions in the position of the turning point.

(3) With the technical solution according to the present disclosure, multiple neutral particle beams can be injected in different positions and angles, which benefit the density distribution optimization of the fast ions in the turning point zone and produce a maximum fusion power with a certain plasma beta.

### BRIEF DESCRIPTION OF THE DRAWINGS

FIG. 1 is a schematic diagram of a magnetic mirror device according to the present disclosure.

FIG. 2 is a schematic diagram of the principle of the technical solution according to the present disclosure.

1. neutral beam injection system
2. magnet system
3. vacuum chamber
4. plasma gun

### DETAILED DESCRIPTION OF EMBODIMENTS

The present disclosure is further illustrated with the following drawings and embodiments, and the protection scope of the present disclosure is not limited to the embodiments.

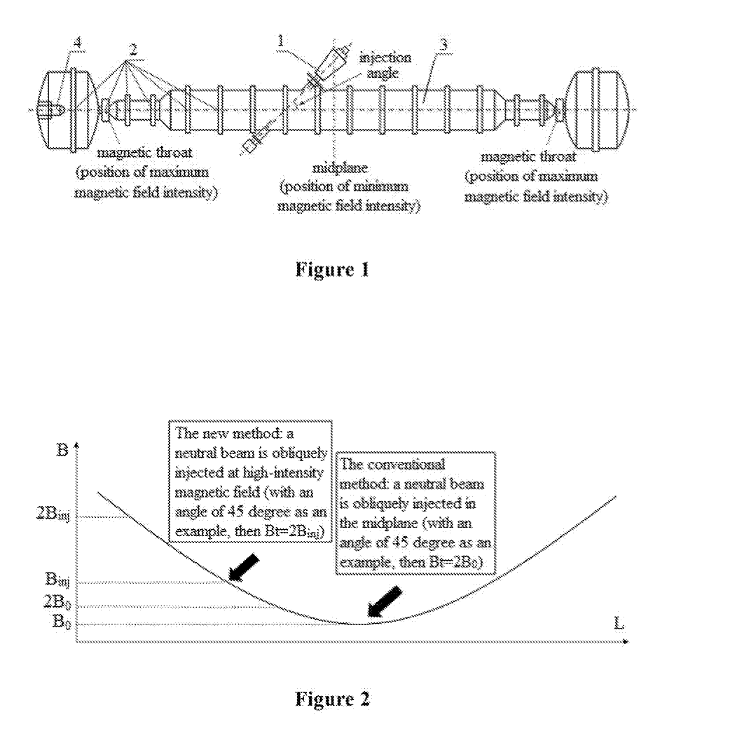

Reference is made to FIG. 1, which is a schematic diagram of a magnetic mirror device according to the present disclosure. The magnetic mirror device mainly includes a neutral beam injection system 1, a magnet system 2, a vacuum chamber 3, a plasma gun 4 and other auxiliary equipment.

The magnet system 2 is configured to form a magnetic field. The plasma gun 4 is configured to shoot plasma into the vacuum chamber 3 to form initial target plasma. The neutral beam injection system 1 is configured to inject a neutral beam in a position at higher magnetic field intensity rather than in the midplane where the minimum magnetic field of the magnetic mirror device.

The position may be any position of the plasma between a minimum magnetic field (midplane) and a maximum magnetic field (magnetic throat) in the magnetic mirror device.

In an embodiment, an injection angle of the neutral beam injection system is acute or obtuse, where the injection angle is an angle between a direction for injecting the neutral particles and an axis direction of the plasma.

In an embodiment, the neutral beam injection system is further configured to inject multiple neutral beams in different positions in an axis direction of the plasma.

In an embodiment, the neutral beam injection system is further configured to inject multiple neutral beams in different positions in the axis direction of the plasma and at different injection angles.

A neutral beam injection method is further provided according to another embodiment, which is applied in a magnetic mirror device, for example, as shown in FIG. 1. The neutral beam injection method includes forming a magnetic field by the magnet system 2; shooting, by the plasma gun 4, plasma into the vacuum chamber 3 to form initial target plasma; and injecting, by the neutral beam injection system 1, a neutral beam in a position at higher magnetic field intensity rather than in the midplane where the minimum magnetic field of the magnetic mirror device.

In order to further illustrate the technical scheme in the present disclosure, the following two exemplary embodiments are described.

### Exemplary Embodiment 1

Plasma is confined by a magnetic mirror system. A maximum magnetic field intensity of a magnet system 2 is 15 T, and minimum magnetic field intensity in the midplane is 1 T, which makes a magnetic mirror ratio be 15. A plasma gun 4 shoots plasma into a vacuum chamber 3 to form initial target plasma with a density of 0.8×10²⁰ m⁻³. After the initial target plasma is generated, a neutral beam injection system 1 starts to work with an injection power of 40 MW to inject particles with energy of 60 keV. The neutral beam is obliquely injected into the plasma at an angle of 30 degrees in a position where the magnetic field intensity is 1.875 T. The generated fast ions gather in the position where the magnetic field intensity is 7.5 T with a density of 1.9×10²¹ m⁻³. The highly concentrated fast ions constantly collide to each other, so as to produce fusion power of 3.67 MW. With injecting neutral beam at position of high field intensity, the fusion energy gain of the magnetic mirror device is increased to 0.09 by changing injection position of the neutral beam, which is two times higher than that of traditional midplane injection method.

### Exemplary Embodiment 2

Plasma is confined by a magnetic mirror system. A maximum magnetic field intensity of a magnet system 2 is 15 T, and minimum magnetic field intensity of midplane is reduced to 0.15 T, which makes a magnetic mirror ratio be 100. A plasma gun 4 shoots plasma into a vacuum chamber 3 to form initial target plasma with a density of 2.7×10²⁰ m⁻³. After the initial target plasma is generated, a neutral beam injection system 1 starts to work with an injection power of 40 MW to inject particles with energy of 60 keV. The neutral beam is obliquely injected into the plasma at an angle of 30 degrees in a position where the magnetic field intensity is 2.5 T. The generated fast ions gather in the position where the magnetic field intensity is 10 T with a density of 5×10²¹ m⁻³. The highly concentrated fast ions constantly collide to each other, so as to produce fusion power of 5.02 MW. With injecting neutral beam at position of high field intensity and improving the mirror ratio, the fusion energy gain of the magnetic mirror device is increased to 0.125 by changing injection position of the neutral beam, which is three times higher than that of traditional midplane injection method.

Referring to FIG. 2, the traditional neutral beam injection method and the proposed method are compared. In the traditional method, the neutral beam is injected into the midplane, while in the newly proposed method the neutral beam is injected into the strong magnetic field.

The comparison of the conventional neutral beam injection method and the proposed method in the present disclosure is summarized in the table 1.

TABLE 1
comparison of two neutral beam injection methods

| | | The new method in present |
|---|---|---|
| | The conventional method | disclosure |
| Plasma confinement | Magnetic intensity of turning point: ${B}_{1} = \frac{{B}_{0}}{{sin}^{2 } θ}$ | Magnetic intensity of turning point: ${B}_{1} = \frac{{B}_{inj}}{{sin}^{2} θ}$ |
| | $Mirror ratio \text{:} R = \frac{{B}_{in}}{{B}_{0}}$ | $Mirror ratio \text{:} R = \frac{{B}_{in}}{{B}_{0}}$ |
| Relationship between B₁ and R | A coupling relationship: $R = \frac{{B}_{max}}{{B}_{1} {sin}^{2} θ}$ | No coupling relationship |
| Method of | By reducing the neutral beam | The neutral beam injection position |
| improving B₁ | injection angle θ, but θ is limited by | adjustment is flexible, which can |
| | the space of the magnet device. | improve B₁ by improving Bᵢₙⱼ. |
| Method of | R cannot be increased largely by | B₁ is decoupled from B₀. Therefore, |
| improving R | raising the maximum magnetic field | the R can be improved by reducing |
| | (Bₘₐₓ) due to the limitation of | B₀, which is not be limited by the |
| | magnet technology, or by reducing | magnetic technology, so R can be |
| | the minimum magnetic field (B₀) but | improved largely. |
| | the fact that it will reduce the | |
| | magnetic field of turning point (B₁). | |

The undetailed part of the present disclosure belongs to the well-known technology in this field.

Although the illustrative embodiments of the present disclosure are described above to facilitate the understanding of the present disclosure by those skilled in the an, it should be noted that the present disclosure is not limited to the scope of the embodiments. A variety of improvements made in the spirit and scope of the present disclosure are obvious to those skilled in the art, and all inventions created using the idea provided in the present disclosure should fall within the scope of protection of the present disclosure.

1. A magnetic mirror device, comprising:
a neutral beam injection system,
a magnet system,
a vacuum chamber, and
a plasma gun, wherein,
the magnet system is configured to form a magnetic field;
the plasma gun is configured to shoot plasma into the vacuum chamber to form initial target plasma;
the neutral beam injection system is configured to inject a neutral beam in a position at higher magnetic field intensity rather than in the midplane where the minimum magnetic field of the magnetic mirror device.

2. The magnetic mirror device according to claim 1, wherein
an injection angle of the neutral beam injection system is acute or obtuse, wherein the injection angle is an angle between a direction for injecting the neutral particles and an axis direction of the plasma.

3. The magnetic mirror device according to claim 1, wherein
the neutral beam injection system is further configured to inject a series of neutral beams in different positions of the axis direction of the plasma.

4. The magnetic mirror device according to claim 2, wherein
the neutral beam injection system is further configured to inject a series of neutral beams in different positions in the axis direction of the plasma and at different injection angles.

5. The magnetic mirror device according to claim 2, wherein the injection angle is 30 degrees.

6. A neutral beam injection method, applied in a magnetic mirror device comprising a neutral beam injection system, a magnet system, a vacuum chamber and a plasma gun, and
the neutral beam injection method comprising:
forming a magnetic field by the magnet system;
shooting, by the plasma gun, plasma into a vacuum chamber to form initial target plasma; and
injecting, by the neutral beam injection system, a neutral beam in a position at higher magnetic field intensity rather than in the midplane where the minimum magnetic field of the magnetic mirror device.

7. The neutral beam injection method according to claim 6, wherein the injecting, by the neutral beam injection system, a neutral beam in a position at higher magnetic field intensity than in the midplane comprises:
injecting, by the neutral beam injection system, a neutral beam at an injection angle that is acute or obtuse, wherein the injection angle is an angle between a direction for injecting the neutral particles and an axis direction of the plasma.

8. The neutral beam injection method according to claim 6, wherein the injecting, by the neutral beam injection system, a neutral beam in a position at higher magnetic field intensity than in the midplane comprises:
injecting, by the neutral beam injection system, a series of neutral beams in different positions in an axis direction of the plasma.

9. The neutral beam injection method according to claim 7, wherein the injecting, by the neutral beam injection system, a neutral beam in a position where the magnetic field in a position at higher magnetic field intensity than in the midplane comprises:
injecting, by the neutral beam injection system, a series of neutral beams in different positions of the magnetic field in the axis direction of the plasma and at different injection angles.

10. The neutral beam injection method according to claim 7, wherein the injection angle is 30 degrees.
